(19) United States
(12) Patent Application Publication
(10) Pub. No.: US 2012/0056993 A1
(43) Pub. Date: Mar. 8, 2012

(54) Dental Field Visualization System with Improved Ergonomics

(76) Inventors: Salman Luqman, Portland, OR (US); Shahin Kharrazi, Portland, OR (US); Mirza M. Luqman, Portland, OR (US)

(21) Appl. No.: 12/877,824

(22) Filed: Sep. 8, 2010

(51) Int. Cl. H04N 13/02; H04N 7/18

(52) U.S. Cl. 348/47; 348/66; 345/8; 386/225; 348/E13.074; 348/E07.085

(57) ABSTRACT

A dentist's field visualization system for acquiring, processing and displaying images and full-motion video from an intraoral camera on a heads-up display.

### FIELD

The invention relates to dental field visualization systems. More specifically, the invention relates to optics, signal processing, display and control for an improved intraoral field visualization system.

### BACKGROUND

Medical professionals practicing in the field of dentistry face many of the same challenges as other sorts of surgeons, but because of the less-invasive and more “routine” nature of many dental procedures, dentists may face those challenges much more often. A busy dentist may see twelve or fifteen patients in a clay, and perform preventative or reconstructive work on many of them.

One difficulty a dentist encounters regularly is that of simply seeing into a patient's mouth. Of course, over the centuries, dentists have developed a wide array of angled mirrors and similar implements, and contemporary practitioners often have articulated, positionable chairs for patients and adjustable light sources, but many dentists nevertheless suffer from back and neck pain caused by their efforts to peer into patients' mouths and get a clear view of their work.

New visualization systems that permit dentists to see their patients' teeth and gums without discomfort (for either party) may be of significant value in this field.

### SUMMARY

A modular system comprising image acquisition, processing and display facilities permits a dental professional to observe and treat conditions in a patient's mouth without directly viewing the area in question.

### BRIEF DESCRIPTION OF DRAWINGS

Embodiments of the invention are illustrated by way of example and not by way of limitation in the figures of the accompanying drawings in which like references indicate similar elements. It should be noted that references to “an” or “one” embodiment in this disclosure are not necessarily to the same embodiment, and such references mean “at least one.”

FIG. 1 shows a dentist using an embodiment of the invention to treat a patient.

FIG. 2 is a block diagram of components that make up an embodiment.

FIG. 3 is a block diagram (sub-diagram) of the data-processing means referred to in FIG. 2.

FIG. 4 is a flow chart outlining a method implemented by an embodiment.

FIG. 5 shows an intraoral camera that can be used with an embodiment of the invention.

FIG. 6 shows a heads-up display that can be used with an embodiment of the invention.

FIG. 7 shows a complete embodiment of the invention.

FIG. 8 shows another complete embodiment, using wireless communication between some of the components.

### DETAILED DESCRIPTION

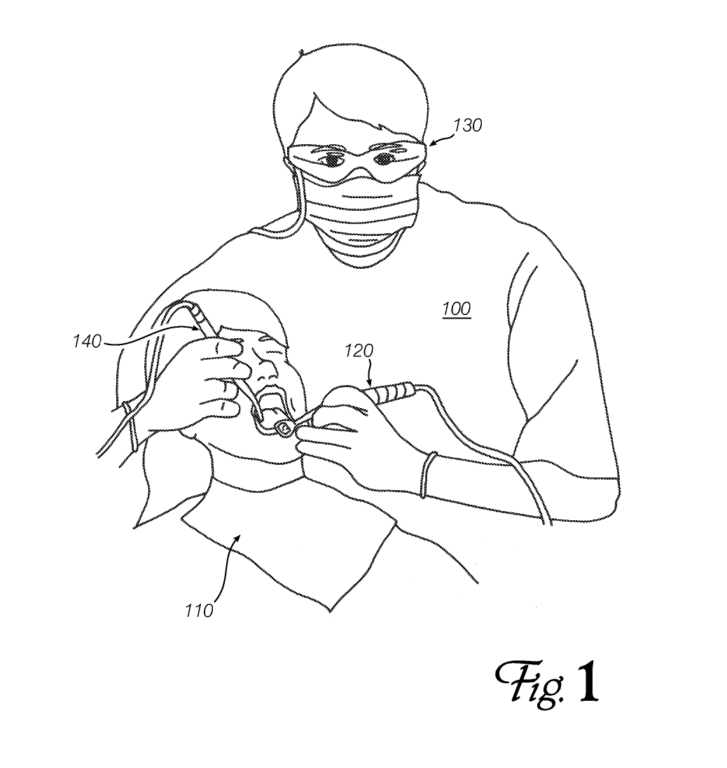

FIG. 1 shows a dentist 100 using an embodiment of the invention to treat a patient 110. The principal elements of the embodiment visible in this figure are an intraoral camera 120 and a heads-up display (“HUD”) 130. An embodiment also comprises data-processing means for preparing the image from camera 120 to be displayed on HUD 130, but the apparatus implementing the processing function may be physically located within camera 120 or HUD 130, or in a separate enclosure; it is not shown in this figure. Dentist 100 also holds a traditional treatment implement 140 in his right hand. This may be, for example, a pneumatic or electric drill, an ultraviolet light source for curing a chemical composition used in treating a condition, or simply a metal probe.

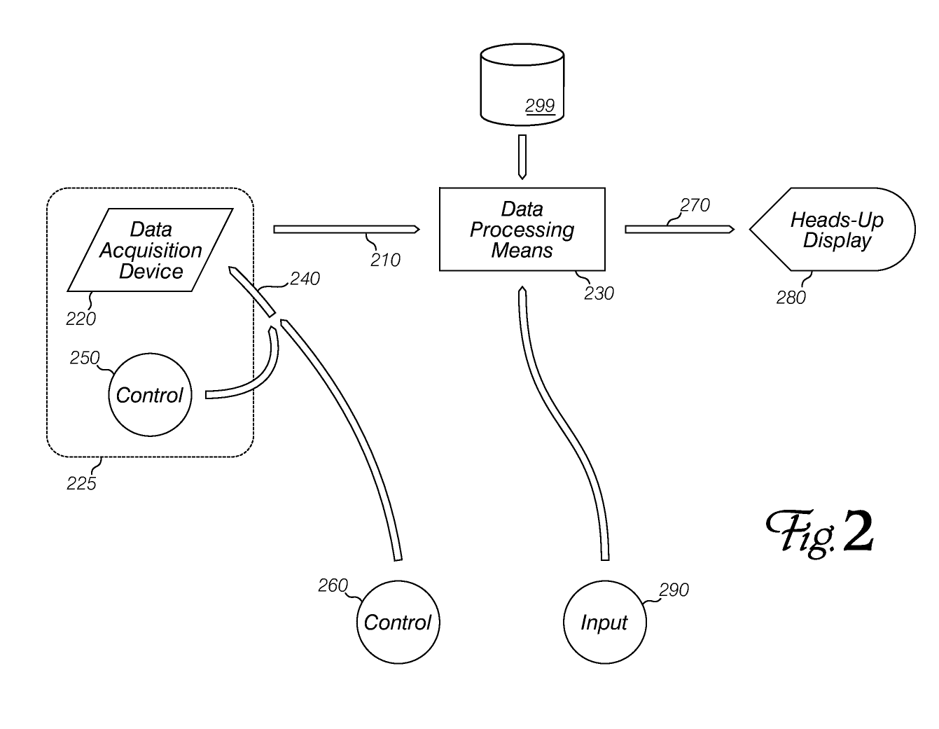

FIG. 2 shows a system diagram interrelating the functional elements of an embodiment. A data acquisition device 220 is deployed at the patient's location and is used to obtain information near the treatment site. In many embodiments, the data acquired are still or video images of the patient, but it is appreciated that some treatment procedures will benefit from the acquisition of information outside the visible-light spectrum (for example, infrared, ultraviolet or even X-ray data).

A first data connection 210 carries acquired data from device 220 to data processing means 230, while a second data connection 240 carries command and control data to device 220 from control means 250, 260. In many embodiments, data connections 210 and 240 will be the two directions of a bi-directional data link such as a Universal Serial Bus (“USB”) connection or a wireless (e.g., radio or optical) link such as a Bluetooth® or Wi-Fi™ connection.

Control means 250 may be a button, switch or other actuator physically located at data acquisition device 220 (as suggested by dashed line 225), and operative to start or stop data acquisition or to change an acquisition parameter. Control means 260 may be located remotely from data acquisition device 220, but may permit a user to exert similar control over the acquisition device by sending a command over data connection 240. For example, control means 260 may be a foot switch operative to activate an optical magnification lens at device 220. In some embodiments, a control means sends a continuous-valued signal to data acquisition device 220 to control an analog function such as the brightness of an illumination feature or the magnification of a variable zoom.

Data processing means 230 receives data from acquisition device 220 and prepares it for presentation on heads-up display (“HUD”) 280. The image is provided to HUD 280 via a second data link 270. Like data connections 210 and 240, data link 270 may be wired or wireless. Control means 250 and 260, or other input devices 290, may send signals to data processing means 230 to adjust its processing of the data for display. For example, a control input may cause data processing means 230 to apply digital magnification to an image, to change the contrast of an image, or to rotate the image.

In one embodiment, data acquisition device 220 comprises accelerometers and gyros to obtain information about the position and motion of the acquisition device, and data processing means 230 automatically adjusts an acquired image by rotating, shifting and/or scaling it to perform stabilization.

In another embodiment, data processing means 230 receives additional information from an auxiliary source 299 and incorporates the additional information into the image presented on HUD 280. For example, auxiliary source 299 may be a treatment history database. Data processing means 230 overlays text data, indicator markers and/or historical images on the live data from data acquisition device 220. Thus, a user of the system can quickly compare a present condition to a previously-recorded condition to assess progress or deterioration.

In the foregoing description, it is appreciated that the physical location of many elements is flexible. For example, the data acquisition device 220 must be at the patient's location, while HUD 280 and some of controls 250, 260, 290 must be with the dentist, but data processing means 230 can be in either location, or at a third, unrelated location. Communication among acquisition, processing, controls and display can be carried by data connections of almost arbitrary length. This flexibility permits repositioning the elements so slightly as to allow the dentist to sit straight up instead of leaning over, or far enough to perform remote diagnosis and treatment of patients in another geographic region.

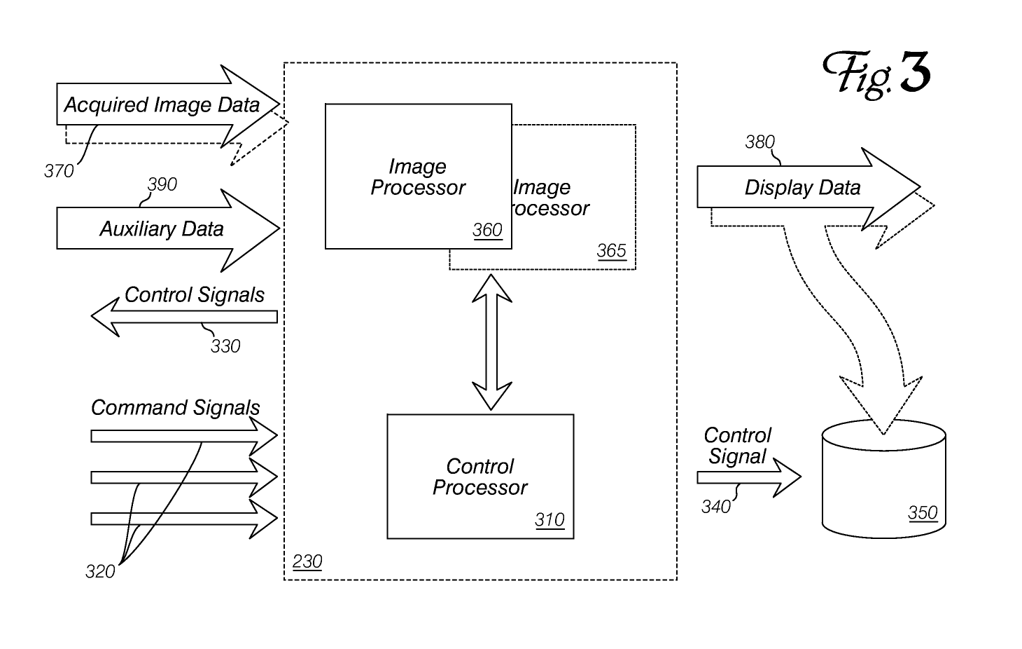

FIG. 3 illustrates the data processing means of an embodiment in greater detail. Data processing means 230 must be able to perform computationally-expensive realtime image processing, and respond quickly to user inputs and other low-frequency events. One way to meet these requirements cost-effectively is to divide the processing among multiple subcomponents. As shown here, a control processor 310 (which may be, for example, a microcontroller of relatively modest capabilities) receives command signals 320 from user-input devices such as a thumb switch, scroll wheel, foot pedal or the like. Processor 310 may interpret these signals 320 and send command signals 330 to change data acquisition parameters (for example, to cause the data acquisition device to switch to higher-magnification optics, or to enable a higher-contrast light source). Other command signals 340 may cause a data recording subsystem 350 to start or stop recording image data.

Separately, an image processor 360 (or a plurality of image processors 365) receive voluminous acquired image data 370 from the data acquisition device, transform it according to the user's wishes and send it (380) to the heads-up display (and, optionally, to the recording subsystem 350). Image processor(s) 360, 365 may also receive auxiliary data 390 as described above and incorporate it into the display stream. Although the control processor 310 may have only modest computational power, image processor(s) 360, 365 should be faster and more capable. In some embodiments, field-programmable gate arrays (“FPGAs”) are suitable for this application.

It is anticipated that changes in processor capability, availability and price will result in corresponding system architectural changes. For example, a hybrid FPGA-CPU device may permit a more-efficient solution than separate MCU and FPGA. Alternately, an inexpensive yet fast processor may be able to perform all the image manipulation in software, yet still respond timely to command inputs. The selection of an appropriate system architecture can be made without undue experimentation based on the information presented herein.

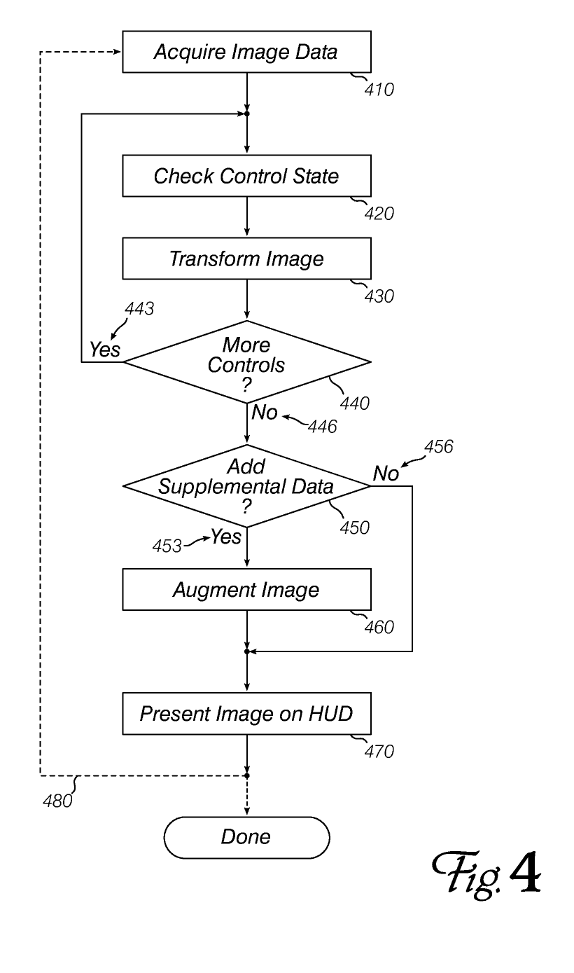

FIG. 4 outlines the operation of an embodiment of the invention. In the system considered here, the data acquisition device is an intraoral camera (either a prior-art unit, or one such as described below). The system acquires an image from the camera (410), then commences processing by checking a control state (420) and transforming the image (430). For example, if the control is a zoom control, then the image processing means may magnify (or shrink) the image. If the control is a contrast control, then the image processing means applies a filter to increase (or decrease) the image contrast. In some embodiments, a control can be used to invert the displayed image (i.e., to show it as a negative image, where dark areas appear white, and light areas appear dark). This transformation often allows the operator to detect abnormal conditions that are difficult to observe under normal lighting and positive imaging.

If there are more controls in the system (440), then the image processing/transform activity continues (443). If there are no more controls to affect the image (446), then the image processing means checks for supplemental data (450). If there is such data (453), the processed image is augmented therewith (460). For example, the image processing means may overlay the current date, time or patient's name; or insert a detail image showing an X-ray of the same area viewed by the camera. Finally, the processed and possibly augmented image is displayed on the heads-up display (470). This process may be repeated (480) as necessary during the treatment of the patient. If new images are prepared and displayed at a high enough frequency (in excess of about 20 Hz), then the system provides what is essentially live (and possibly augmented or enhanced) video of the treatment site. In fact, this is a common mode of usage of an embodiment: the operator uses the live video images to diagnose, plan and conduct treatment. Still images from the video stream may be captured and saved for future reference by operating an appropriate control. Some embodiments may also permit the recording of video clips for later review. An embodiment may include a microphone to record audio notes, which can be saved with a still image or recorded video.

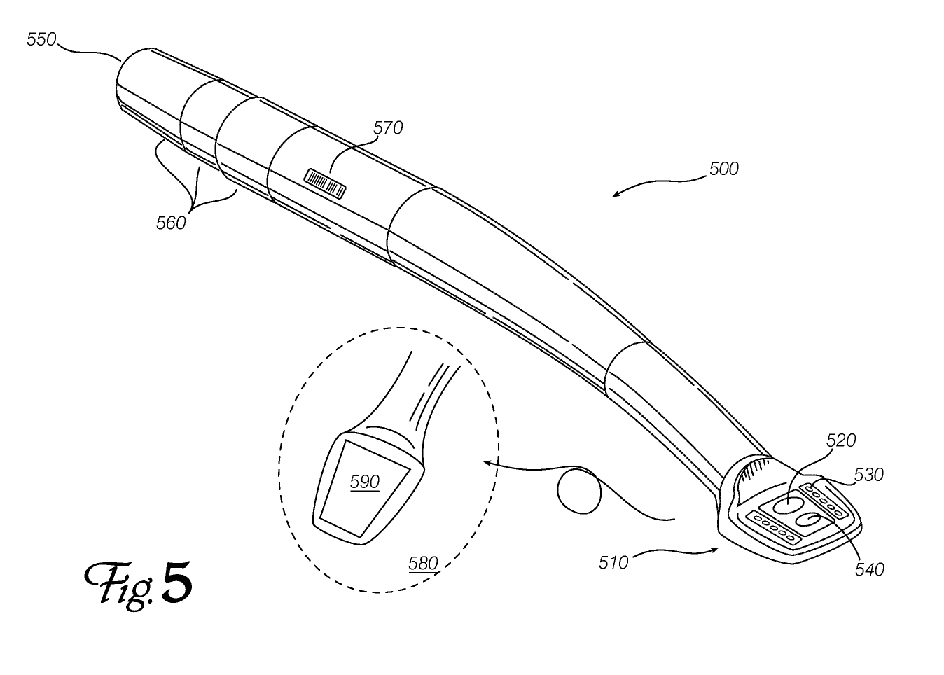

FIG. 5 shows some features of a data acquisition device (generally 500) according to an embodiment of the invention. An image acquisition package 510 comprising a visible-light camera lens 520, a second camera lens 540, and an illumination feature 530 is placed at one extremity of the device; in a wired embodiment, a data communication cable may exit from the opposite extremity 550. A segmented structure 560 may permit insertion or removal of intermediate sections to match the reach and angle desired by the user. Thumb wheel 570 is an example of a control disposed on the image acquisition device to adjust its operation.

In the embodiment pictured here, the illumination feature 530 comprises ten individual light sources placed on either side of lenses 520 and 540. The number of light sources is not critical, but it is preferred to have more than one, and that the sources be distributed relatively evenly about the lenses so that evenly-illuminated images of the work area can be obtained.

An acquisition device may include internal sensors also, such as single- or multiple-axis accelerometers, solid-state gyroscopes, temperature sensor or the like. Illumination feature 530 may offer variable brightness and/or different colors of light. For example, in one embodiment, one or more of the light sources may emit blue light. The operator may switch from normal (e.g., white) light to blue so that cracks in tooth surfaces become more visible. In some embodiments, the illumination feature may do double duty as a light source for curing adhesive composites (for example, ultraviolet emitters can cause photosensitive epoxies to harden). The control system should incorporate safety interlocks if ultraviolet lights are present, to avoid damaging the camera optics or other parts of the system. Multiple camera devices may permit different native (optical) magnifications, depths of field, or light frequency sensitivities. In some embodiments, two cameras provide images from which the image processing means can construct a three-dimensional stereoscopic image for presentation to the user via the heads-up display.

In some embodiments, the image-acquisition package 510 may be detached and replaced with a differently-configured unit, comprising, for example, cameras with lenses of different focal lengths. A removable image head may also facilitate sterilization, or allow system repair without discarding the entire data acquisition device 500. In some systems, the camera unit and handpiece may be covered with a sterile, transparent cover (not shown). This may be clone when it is not possible to sterilize the instrument with heat and pressure, clue to the risk of damaging the camera or electronics.

It is appreciated that a data acquisition device such as that described with reference to FIG. 5 may also incorporate traditional imaging features and functions. For example, the underside of image acquisition package 510, the side opposite the camera lens(es), may be fitted with an ordinary mirror 590, as shown in inset 580, so the camera can be flipped over and used to view the work area through a standard optical reflection. In some embodiments, the imaging handpiece may be combined with a pneumatic or electric drill, ultrasonic probe/manipulator, laser ablation unit, or other functional tool. With such an “all-in-one” embodiment, the single tool may suffice for both visualization and treatment.

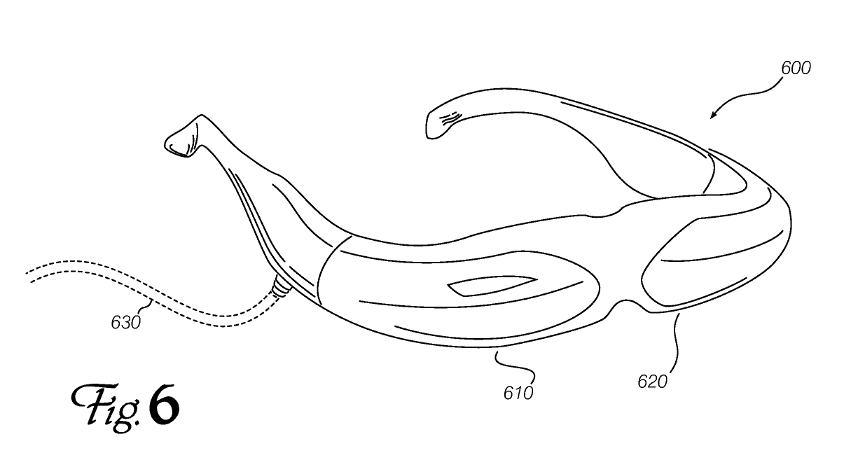

FIG. 6 shows a heads-up display that may be used in an embodiment of the invention. This display (600, generally) is worn similarly to eyeglasses. The frame is constructed to place the “lenses” 610, 620 at slightly above the wearer's line of vision. The lenses themselves may be opaque or semi-opaque, as the display is actually inside the glasses (produced, for example, by liquid crystal, organic light emitting diodes, or another optical system comprising light emitters, mirrors, lenses and so on). In some embodiments, both displays show a single image, while in other embodiments, the displays operate independently and can show completely different images. The latter type of display can present a stereoscopic or “3-D” image to its user. A stereoscopic image can be acquired from an intraoral camera comprising two separate cameras, or can be synthesized by the data processing means based on a single-vantage-point camera and other information available. When operating in stereoscopic mode, a control to rotate the acquired images may be very useful in constructing a comprehensible set of images for display. In addition, in stereoscopic mode, a control to artificially shift the apparent vantage points farther apart or closer together may help produce an image that can be re-intergrated comfortably by the dentist.

A HUD according to an embodiment of the invention may be wired (630) or wireless (using Bluetooth® or Wi-Fi™, for example). Since this embodiment places the display above the wearer's line of sight, he also enjoys an unobstructed view of the patient directly, at and below his normal line of sight. Other embodiments may use different optical systems to cast a virtual pixel display over some or all of the user's visual field. A control of the system may adjust the intensity or opaqueness of the display so that the desired information is easily perceived.

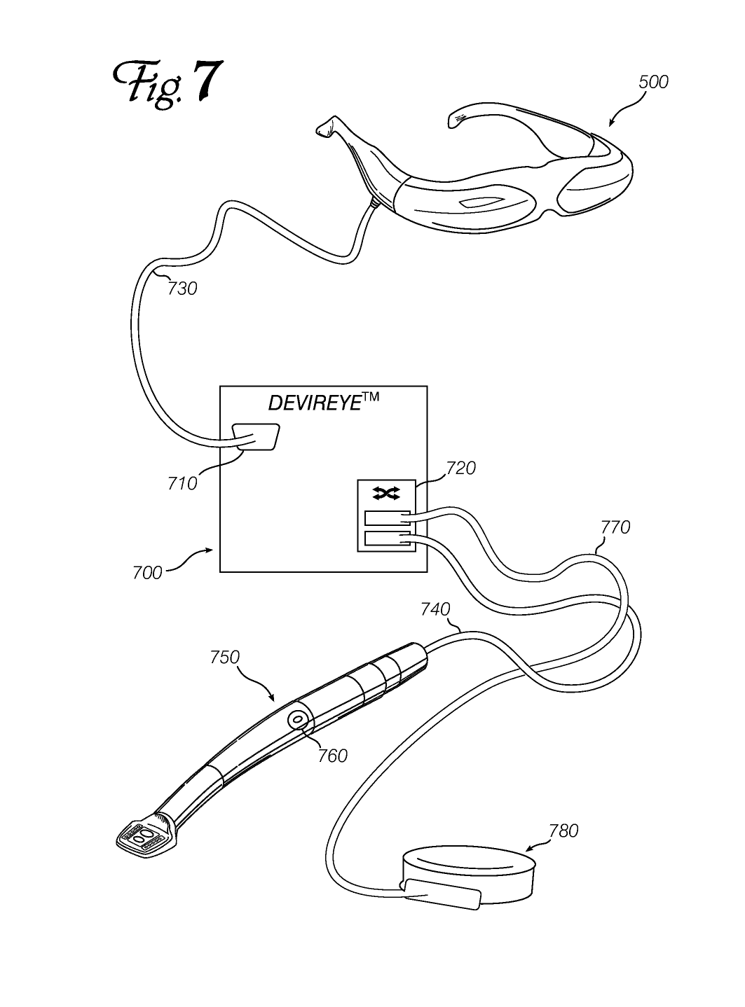

FIG. 7 shows a complete system according to an embodiment of the invention. A programmable computer 700 including a video port 710 and a plurality of Universal Serial Bus (“USB”) ports 720 is configured with software to cause it to perform methods including that described in FIG. 4. Video port 710 is connected via a cable 730 to heads-up display 500. In this embodiment, HUD 500 is a stereoscopic display with image resolution of approximately 1024 pixels by 768 pixels presented to each eye. (HUDs of other resolutions can also be used with an embodiment.) In some systems, camera and HUD image resolutions will be chosen to be equal, so that the image processor need not re-scale or re-size the image before display. (Such scaling often introduces undesirable visual artifacts.) In other systems, the camera resolution will be chosen to exceed HUD resolution (perhaps by a factor of two or more). In these systems, the image processor may select a sub-area of the entire camera image for display on the HUD.

An intraoral camera 750, like that described in FIG. 5, is connected to computer 700 by a USB cable 740. Camera 750 comprises a three-way thumb switch (circled at 760) that permits the user to zoom in, out, or capture the currently-displayed image.

Finally, this system comprises a foot switch 780, also connected to computer 700 by USB cable 770. Foot switch 780 can be configured to switch camera illumination sources or to adjust the system operation in another way.

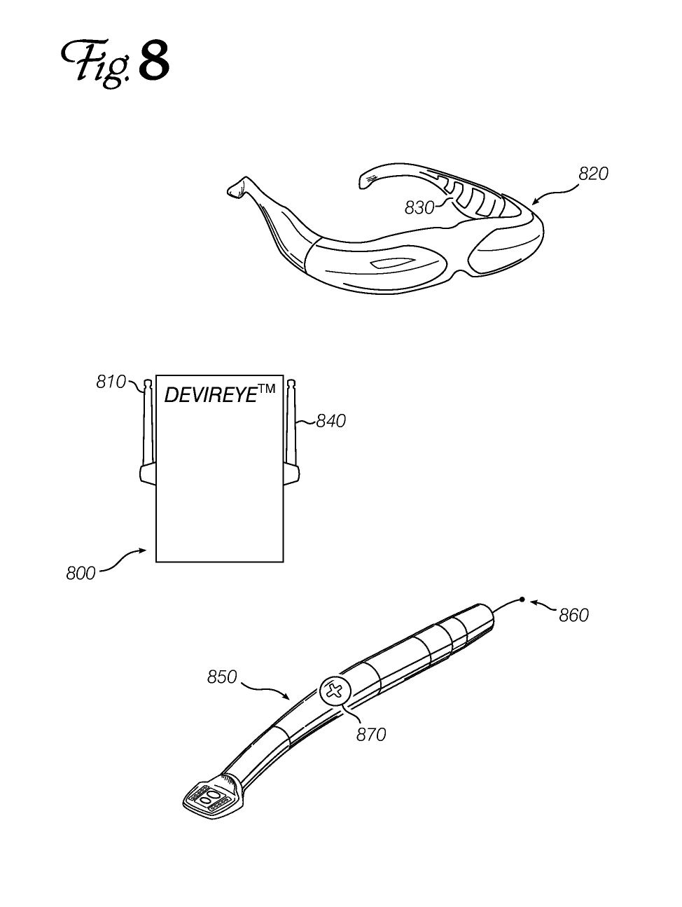

FIG. 8 shows the components of a wireless (e.g., radio-communication based) system. A main system unit 800 includes an antenna 810 to communicate with heads-up display (“HUD”) 820 (the HUD is fitted with an internal antenna formed into a temple of the display, shown here as serpentine track 830). A second antenna 840 permits the system to communicate with intraoral camera 850. This camera has a small external antenna 860, but other communication frequencies may permit the use of internal antennas, or a segment of the camera body may serve as a circular patch antenna. This camera also has a four-way control (circled at 870) to control several system functions.

An embodiment of the invention may comprise a machine-readable medium having stored thereon data and instructions to cause a general-purpose programmable processor to perform operations as described above. In other embodiments, the operations might be performed by specific hardware components that contain hardwired logic. Those operations might alternatively be performed by any combination of programmed computer components and custom hardware components.

Instructions for a programmable processor may be stored in a form that is directly executable by the processor (“object” or “executable” form), or the instructions may be stored in a human-readable text form called “source code” that can be automatically processed by a development tool commonly known as a “compiler” to produce executable code. Instructions may also be specified as a difference or “delta” from a predetermined version of a basic source code. The delta (also called a “patch”) can be used to prepare instructions to implement an embodiment of the invention, starting with a commonly-available source code package that does not contain an embodiment.

In the preceding description, numerous details were set forth. It will be apparent, however, to one skilled in the art, that the present invention may be practiced without some of these specific details. In some instances, well-known structures and devices are shown in block diagram form, rather than in detail, in order to avoid obscuring the present invention.

Some portions of the detailed descriptions may have been presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the preceding discussion, it is appreciated that throughout the description, discussions utilizing terms such as “processing” or “computing” or “calculating” or “determining” or “displaying” or the like, refer to the action and processes of a computer system or similar electronic computing device, that manipulates and transforms data represented as physical (electronic) quantities within the computer system's registers and memories into other data similarly represented as physical quantities within the computer system memories or registers or other such information storage, transmission or display devices.

The present invention also relates to apparatus for performing the operations herein. This apparatus may be specially constructed for the required purposes, or it may comprise a general purpose computer selectively activated or reconfigured by a computer program stored in the computer. Such a computer program may be stored in a computer readable storage medium, including without limitation any type of disk including floppy disks, optical disks, compact disc read-only memory (“CD-ROM”), and magnetic-optical disks, read-only memories (ROMs), random access memories (RAMs), eraseable, programmable read-only memories (“EPROMs”), electrically-eraseable read-only memories (“EEPROMs”), Flash memories (either “NAND” or “NOR” Flash), magnetic or optical cards, or any type of media suitable for storing computer instructions.

The algorithms and displays presented herein are not inherently related to any particular computer or other apparatus. Various general purpose systems may be used with programs in accordance with the teachings herein, or it may prove convenient to construct more specialized apparatus to perform the required method steps. The required structure for a variety of these systems will be recited in the claims below. In addition, the present invention is not described with reference to any particular programming language. It will be appreciated that a variety of programming languages may be used to implement the teachings of the invention as described herein. For example, Field-Programmable Gate Arrays (“FPGAs”) are often programmed using a language called Verilog, but another language, “VHDL,” is also useable.

The applications of the present invention have been described largely by reference to specific examples and in terms of particular allocations of functionality to certain hardware and/or software components. However, those of skill in the art will recognize that beneficial image acquisition, processing and display can also be achieved by software and hardware that distribute the functions of embodiments of this invention differently than herein described. Such variations and implementations are understood to be captured according to the following claims.

We claim:

1. A system comprising:
an intraoral camera to acquire an image from a patient's mouth;
image processing means to receive and adjust the image; and
a heads-up display to present the adjusted image to a user.

2. The system of claim 1 wherein the system acquires, adjusts and presents the image repeatedly to form a live video sequence from the patient's mouth.

3. The system of claim 2, further comprising:
a control means to cause the system to record one still image.

4. The system of claim 2, further comprising:
a control means to cause the system to begin recording the live video sequence.

5. The system of claim 2, further comprising:
a control means to cause the image processing means to adjust the image by producing a negative image.

6. The system of claim 1 wherein the intraoral camera transmits the image to the image processing means via a wired connection.

7. The system of claim 1 wherein the intraoral camera transmits the image to the image processing means via a wireless connection.

8. The system of claim 1 wherein the image processing means transmits the adjusted image to the heads-up display via a wired connection.

9. The system of claim 1 wherein the image processing means transmits the adjusted image to the heads-up display via a wireless connection.

10. The system of claim 1 wherein the image processing means comprises a Field-Programmable Gate Array (“FPGA”) to adjust the image.

11. The system of claim 1, further comprising:
an auxiliary data source to provide additional information to the image processing means; wherein
the image processing means overlays the additional information on the adjusted image before the adjusted image is presented to the user.

12. The system of claim 1 wherein the intraoral camera comprises a plurality of cameras to acquire a plurality of images from the patient's mouth and the heads-up display comprises a plurality of independent image-presentation means, the system further comprising:
stereoscopic image processing logic to present different images on the plurality of independent image-presentation means, to create the impression of a three-dimensional view from the intraoral camera.

13. The system of claim 1 wherein the intraoral camera comprises a plurality of illumination features, each illumination feature to produce a different color of light.

14. The system of claim 13 wherein a first illumination feature produces substantially white light, and a second illumination feature produces substantially blue light.

15. The system of claim 13 wherein one of the plurality of illumination features produces ultraviolet light.

16. A system comprising:
an intraoral camera for acquiring a series of images of an interior of a patient's mouth;
an image processor to perform at least one of a scaling operation, a contrast-changing operation or a rotation operation on each image of the series of images to produce a modified series of images; and
a heads-up display to present the modified series of images.

17. The system of claim 16 wherein the intraoral camera comprises a reflective surface opposite a lens of the intraoral camera.

18. A system comprising:
an intraoral camera including a variable-magnification optical system, a light source and a control input device;
a heads-up display (“HUD”) including two independent display screens, each capable of displaying a color image at 1024 by 768 pixel resolution, said HUD configured to be worn similarly to eyeglasses; and
a programmable computer coupled to the intraoral camera and to the heads-up display, said programmable computer containing instructions to cause the computer to acquire an image from the intraoral camera, adjust the image according to the control input device, and cause the image to be displayed on the independent display screens of the HUD.

19. The system of claim 18, further comprising a foot switch coupled to the programmable computer, said foot switch operative to adjust one of a magnification of the variable-magnification optical system or an intensity of the light source.

20. The system of claim 18 wherein a resolution of the intraoral camera exceeds the resolution of the HUD, said programmable computer operative to select a sub-portion of the image from the intraoral camera to be adjusted and displayed on the HUD.
